(19) United States
(12) Patent Application Publication
(10) Pub. No.: US 2008/0290724 A1
(43) Pub. Date: Nov. 27, 2008

(54) Wheel Axle Bearing Arrangement

(75) Inventors: Christian Wargh, Eskilstuna (SE); Bertil Lindell, Eskilstuna (SE)

Correspondence Address: WRB-IP LLP, 1217 KING STREET, ALEXANDRIA, VA, 22314, US

(73) Assignee: Volvo Construction Equipment Holding Sweden AB, Eskilstuna (SE)

(21) Appl. No.: 12/097,265

(22) PCT Filed: Dec. 15, 2005
(86) PCT No.: PCT/SE05/01944

§ 371 Date: Jun. 13, 2008

(51) Int. Cl. B60B 35/00

(52) U.S. Cl. 301/125

(57) ABSTRACT

A wheel axle bearing arrangement includes a wheel axle housing and a wheel axle support, which is configured to be rigidly connected to a vehicle frame, and a bearing arrangement configured to pivotably mount the wheel axle housing relative to the wheel axle support. The bearing arrangement includes at least two bearing sleeves arranged side by side.

### BACKGROUND AND SUMMARY

The present invention relates to a wheel axle bearing arrangement comprising a wheel axle housing and a wheel axle support, which is configured to be rigidly connected to a vehicle frame, and a bearing means configured to pivotably mount the wheel axle housing relative to the wheel axle support.

One or more axles of a vehicle may be pivotally attached to the vehicle frame so as to accommodate movement of the vehicle over rough terrain. It is known to provide oscillating drive axle structures for large off road vehicles so that all drive wheels will stay in contact with the ground regardless of the unevenness of the terrain.

The invention will be described below in a case in which it is applied in a work vehicle constituted by a wheel loader. This is to be regarded only as an example of a preferred application. The term work vehicle comprises different types of material handling vehicles like construction machines, such as a wheel loader, a backhoe loader, a motor grader and an excavator. The invention may be applied in other types of off road type of vehicles like industrial tractors and trucks.

More specifically, the bearing means is configured to permit the wheel axle housing to pivot around an imaginary axis, which extends perpendicular to an axial direction of the wheel axle housing. Thus, the imaginary axis is in parallel with a longitudinal direction of a vehicle carrying the wheel axle housing. Further, the bearing means is configured to permit the wheel axle housing to move back and forth a small distance relative to the wheel axle support in a direction perpendicular to the axial direction of the wheel axle housing during operation.

In a vehicle carrying the wheel axle housing, a propeller shaft extends in the vehicle longitudinal direction and transmits the driving power from a transmission to a differential in the wheel axle housing. The differential has the job of adapting the speed of the driving wheels at the same time as retaining the total driving power. A left and right drive shaft connects each wheel to the differential. The propeller shaft extends through an opening in the wheel axle housing. The bearing means is arranged around the opening in the wheel axle housing between an annular portion of the wheel axle support and an annular portion of the wheel axle housing.

A wheel axle support is normally arranged on either side of the wheel axle housing in the vehicle longitudinal direction and each support has bearing means permitting said pivoting motion.

It is known to design the wheel axle bearing arrangement such that periodic maintenance is required. The lubricant is in such a construction normally formed by a grease. It is also known to design the wheel axle bearing arrangement with lubricant for a lifetime lubrication, with no service or periodic maintenance being required. The lubricant is in such a construction normally formed by an oil.

A trunnion mounted axle with lifetime lubrication is disclosed in U.S. Pat. No. 3,949,826. A bearing sleeve of a metallic composition is arranged in each bearing point in such a manner that the wheel axle housing is pivotably mounted relative to the wheel axle support.

It is desirable to achieve a wheel axle bearing arrangement, which has a longer life than previously known such arrangements. It is also desirable that the arrangement should be more cost-efficient to produce and/or time-efficient to mount.

According to an aspect of the present invention, a wheel axle bearing arrangement comprises a wheel axle housing and a wheel axle support, which is configured to be rigidly connected to a vehicle frame, and a bearing means configured to pivotably mount the wheel axle housing relative to the wheel axle support characterized in that the bearing means comprises at least two bearing sleeves arranged side by side.

Thus, the available bearing distance in one wheel axle support is divided into a plurality of sleeve receiving portions, each for a single bearing sleeve. Edge loads on the sleeve, which are caused by that the sleeve may be somewhat tilted during operation, are reduced by virtue of the fact that each sleeve accommodates a smaller distance. By reducing these edge loads, the wear on the individual sleeve will be reduced and the life longer.

According to a preferred embodiment, at least one of the bearing sleeves is discontinuous in its circumferential direction. This sleeve design creates conditions for an improved lubrication since the sleeve will not be press-fitted to the adjacent surfaces of the wheel axle housing and the wheel axle support. It also creates conditions for an easier mounting. The bearing sleeve is preferably flexible in its circumferential direction for further facilitating installation. The ends of the sleeve may be pressed together to an overlapping condition and the compressed sleeve may thereafter be placed in its desired position in a groove in the wheel axle support.

According to a further preferred embodiment, at least one of the bearing sleeves is arranged in such a manner that it is permitted to move relative to an adjacent surface of the wheel axle housing. Such an arrangement creates conditions both for an improved lubrication and a reduced wear on the sleeve.

According to a further preferred embodiment, opposite surfaces of the wheel axle housing and the wheel axle support define a lubrication reservoir in which the bearing sleeves are positioned, and that the reservoir is designed for being one-off filled with a lubricant. Such a design with a lifetime lubrication eliminates problems for and costs with service and periodic maintenance and also benefits the environment. The lubricant is preferably an oil. According to a further preferred embodiment, said bearing sleeves are formed by a non-metallic material, preferably a thermoset material, and more especially a reinforced (armoured) thermoset material. Such bearing sleeves are cost-efficient in manufacture and have a sufficient strength for the application in question.

Further preferred embodiments and advantages therewith will be apparent from the following description.

### BRIEF DESCRIPTION OF THE DRAWINGS

The invention will be explained below, with reference to the embodiments shown on the appended drawings, wherein

FIG. 1 schematically shows a wheel loader from FIG. 1 in a side view,

FIG. 2 shows a wheel axle and associated wheel axle supports of the wheel loader in a perspective view,

FIG. 3 shows a part of a wheel axle support from FIG. 2 in a cut perspective view, and

FIG. 4 shows a bearing means in the wheel axle support from FIG. 3 in an enlarged view,

FIG. 5 shows two annular, discontinuous bearing sleeves from FIG. 4, and

FIG. 6 shows a wheel axle housing and a wheel axle support of the wheel loader from FIG. 1 in a cut cross section view.

### DETAILED DESCRIPTION

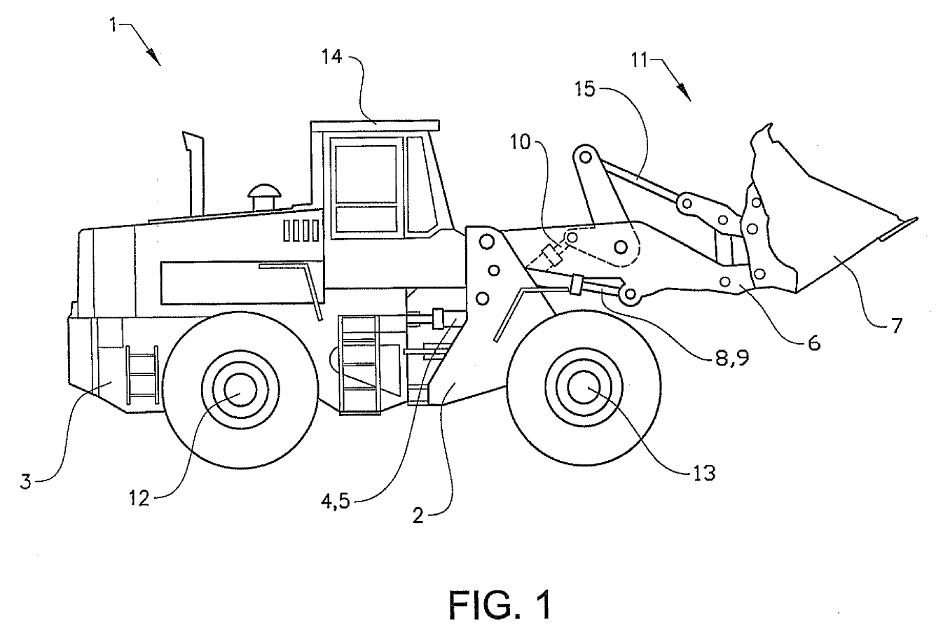

FIG. 1 shows a wheel loader 1. The body of the wheel loader 1 comprises a front body section 2 and a rear body section 3, which sections each has a pair of half shafts (drive shafts) 12,13. The rear body section 3 comprises a cab 14. The body sections 2,3 are connected to each other in such a way that they can pivot in relation to each other around a vertical axis by means of two actuators in the form of hydraulic cylinders 4,5 arranged between the two sections. The hydraulic cylinders 4,5 are therefore arranged one on each side of the wheel loader 1 in order to turn the wheel loader 1. Thus, the wheel loader 1 is articulated.

The wheel loader 1 comprises an equipment 11 for handling objects or material. The equipment 11 comprises a load-arm unit 6 and an implement 7 in the form of a bucket fitted on the load-arm unit. A first end of the load-arm unit 6 is pivotally connected to the front vehicle section 2. The implement 7 is pivotally connected to a second end of the load-arm unit 6.

The load-arm unit 6 can be raised and lowered relative to the front section 2 of the vehicle by means of two second actuators in the form of two hydraulic cylinders 8,9, each of which is connected at one end to the front vehicle section 2 and at the other end to the load-arm unit 6. The bucket 7 can be tilted relative to the load-arm unit 6 by means of a third actuator in the form of a hydraulic cylinder 10, which is connected at one end to the front vehicle section 2 and at the other end to the bucket 7 via a link-arm system 15.

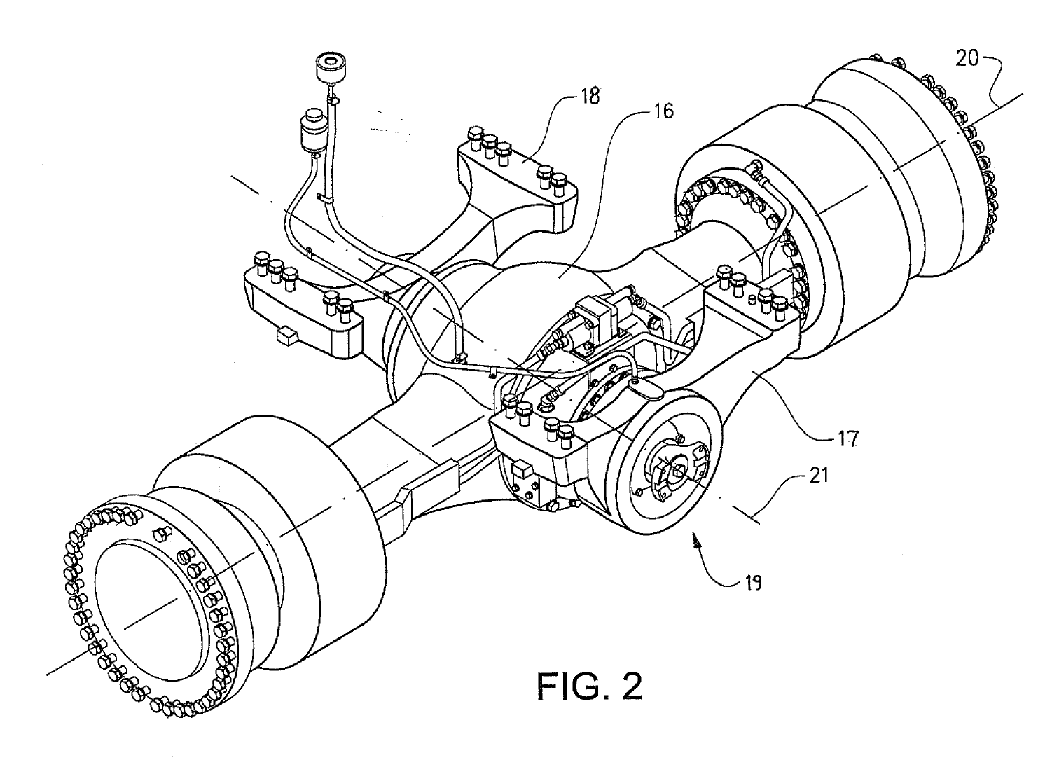

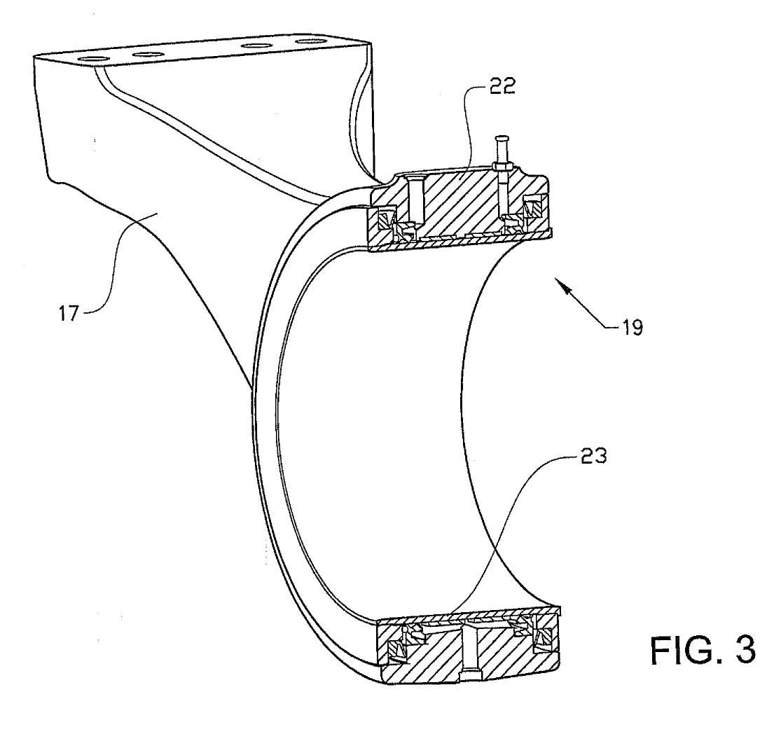

A wheel axle housing 16 is shown in FIG. 2. A first and second wheel axle support 17,18 is arranged on opposite sides of the wheel axle housing 16. The wheel axle supports 17,18 are configured to be rigidly connected to a vehicle frame. A bearing means 19 is configured to pivotably mount the wheel axle housing 16 relative to the first wheel axle support 17, see also FIGS. 3-5. The wheel axle housing 16 defines an axial direction 20. The bearing means 19 is configured to permit the wheel axle housing 16 to pivot around an imaginary axis 21, which extends perpendicular to the axial direction 20. Thus, the imaginary axis 21 is in parallel with a longitudinal (forward) direction of the wheel loader 1.

Further, the bearing means 19 is configured to permit the wheel axle housing 16 to move a small distance back and forth relative to the wheel axle supports 17,18 in a direction perpendicular to the axial direction 20 of the wheel axle housing 16 during operation.

FIG. 3 shows a part of the first wheel axle support 17 in a cut perspective view. The wheel axle support comprises an outer annular, circular portion 22. Further, wheel axle housing 16 comprises a correspondingly shaped inner annular, circular portion 23. The inner annular, circular portion 23 is, according to the shown embodiment, formed by a tubular part, which is rotationally rigidly connected to a main part of the wheel axle housing 16. The bearing means 19 is positioned between the annular inner and outer portions 22,23 so as to permit the wheel axle housing 16 to pivot relative to the wheel axle support 17.

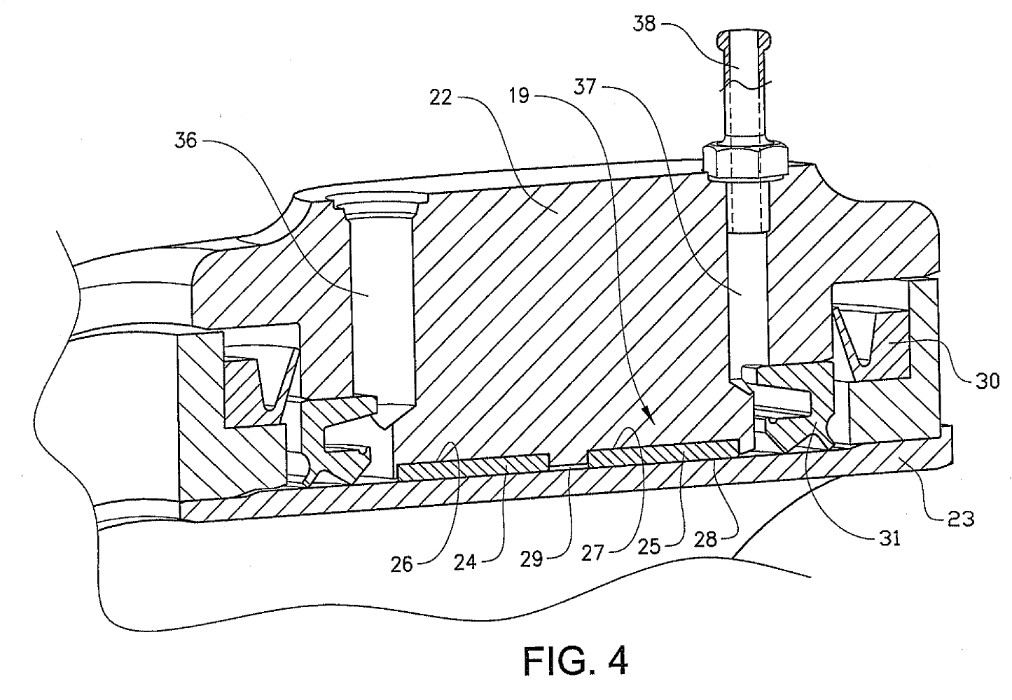

FIG. 4 shows the bearing means 19 of FIG. 3 in an enlarged view. The bearing means 19 comprises at least two annular bearing sleeves 24,25 arranged side by side within a total available bearing width. Each bearing sleeve 24,25 has a flat configuration. An inner surface of each sleeve 24,25 faces an outer surface of the annular portion 23 of the wheel axle housing 16. An outer surface of each sleeve 24,25 faces an inner surface of the annular portion 22 of the wheel axle support 17. More specifically, two grooves 26,27 are formed in the annular portion 22 of the wheel axle support 22 for accommodating the two bearing sleeves 24,25.

Each bearing sleeve 24,25 is arranged in such a manner that it is permitted to move relatively easily relative to an adjacent surface of the annular portion 23 of the wheel axle housing 16. Said surface of the annular portion 23 has a relatively fine structure in order to form a glide surface for the sleeves 24,25. At least rotational relative movement is permitted. Axial relative movement is preferably also permitted.

Each of the bearing sleeves 24,25 is further arranged in such a manner that it is also permitted to move relative to an adjacent surface of the wheel axle support 22 when the arrangement is subjected to stronger impacts, like blows or jerks. At least rotational relative movement is permitted. Axial relative movement is preferably also permitted. Such an arrangement creates conditions both for an improved lubrication and a reduced wear on the sleeve.

The adjacent surface of the wheel axle support 22 has a more rough structure relative to the structure of the glide surface of the wheel axle housing 16. The sleeves 24,25 therefore are relatively firmly connected to the wheel axle support surface. The glide surface of the wheel axle housing 16 therefore forms a main, prioritized glide surface. The bearing sleeves 24, 25 have a somewhat loose fit relative to the adjacent surface of the wheel axle housing 23.

A wheel axle housing surface 28 facing the bearing sleeves 24,25 comprises a metallic material, preferably iron. The wheel axle support surface 26,27 facing the bearing sleeves 24,25 also comprises a metallic material, preferably iron. Said bearing sleeves 24,25 are however formed by a non-metallic material, preferably a thermoset material and especially a reinforced (armoured) thermoset material. It has turned out that woven bakelite (phenoplast) or other type of woven plastic material is especially advantageous in that it is cost-effective in manufacture and durable in this application.

The opposite surfaces 26,28 of the wheel axle housing and the wheel axle support define a lubrication reservoir 29 in which the bearing sleeves 24,25 are positioned. The reservoir 29 is designed for being one-off filled with a lubricant. The lubricant is preferably an oil. Sealing means 30,31 is provided to seal the oil reservoir 29.

Two ports 36,37 are in communication with the reservoir 29. The ports 36,37 serve for one-off filling of the reservoir 29 with oil. A first 36 of the ports is closed by means of a plug after said one-off filling procedure. A second 37 of the ports is used for venting the reservoir 29 for pressure control at different oil temperatures. A nipple 38 is positioned in the port 37 and a hose (not shown) is connected to the nipple. According to a first alternative, the hose is connected to the axle venting system. According to a second alternative, the hose is connected to an oil container externally of the wheel axle housing 16. The container may be used for monitoring that there is no leakage and a sufficient amount of oil in the sleeve bearing reservoir 29.

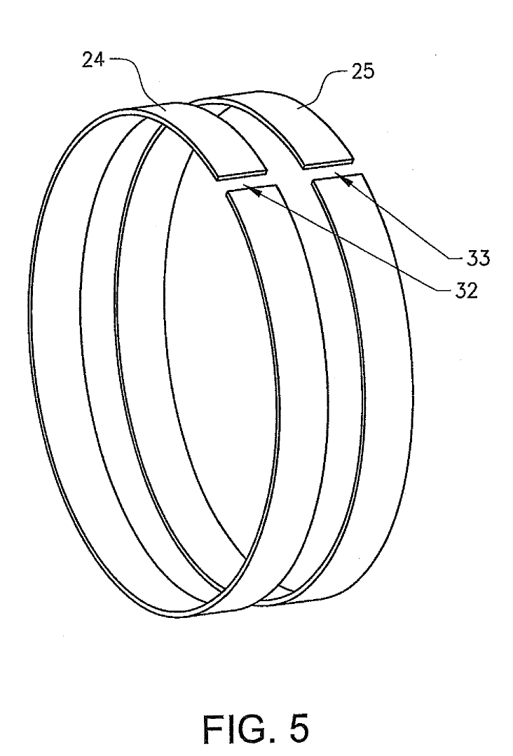

FIG. 5 shows the two bearing sleeves 24,25 in a perspective view. The bearing sleeve 24,25 is of a substantially rigid composition. Each bearing sleeve 24,25 is discontinuous in its circumferential direction, see interruptions 32,33. Thanks to the discontinuity, the bearing sleeve 24,25 is flexible in the circumferential direction in that it may be compressed. In other words, the ends of the annular sleeve may be brought to an overlapping condition, which facilitates mounting. The bearing sleeve 24,25 has a straight cut defining the interruption in order to permit an advantageous oscillating movement. In other words, the cut extends substantially in parallel with the axial direction of the sleeve.

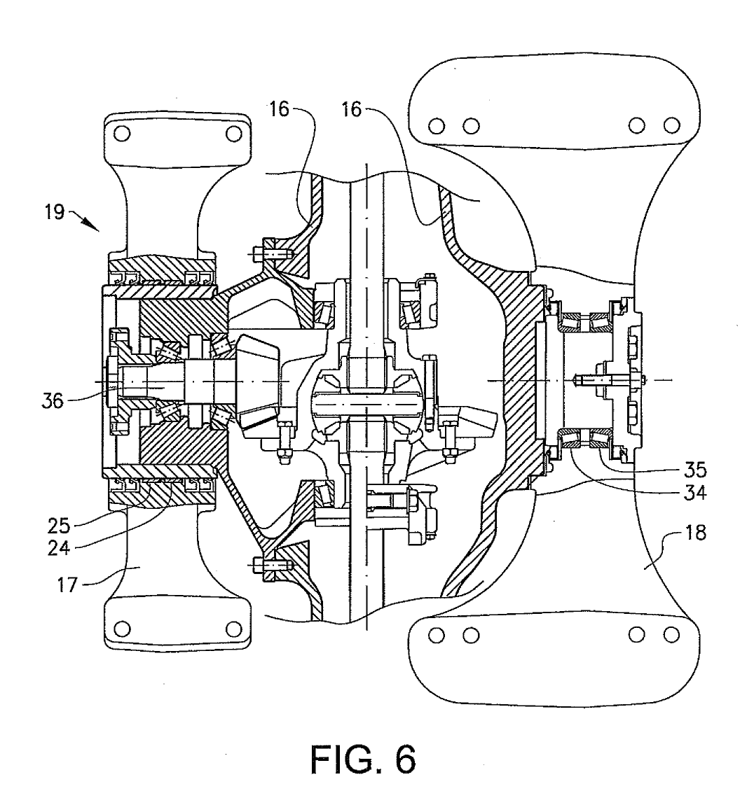

FIG. 6 shows a cross section view of a wheel axle bearing device. The first wheel axle support 17 is provided with the bearing sleeves 24,25 for pivotally mounting the wheel axle housing 16. The second wheel axle support 18 is provided with tapered roller bearings 34,35 for pivotally mounting the wheel axle housing 16. The bearing arrangement with the roller bearings 34,35 obstructs the wheel axle housing 16 from any movements back and forth in the axial direction relative to the second wheel axle support 18. A pinion 36 forms an input shaft to the drive shafts in the wheel axle housing 16. The bearing arrangement 19 comprising the sleeves 24,25 is positioned around the pinion 36.

The invention is not in any way limited to the above described embodiments, instead a number of alternatives and modifications are possible without departing from the scope of the following claims.

According to an alternative to the configuration of FIG. 6, the tapered roller bearings 34,35 may be replaced by a corresponding bearing arrangement 19 as the one shown in FIGS. 3-5, thus comprising a plurality of bearing sleeves arranged side by side. The bearing sleeves in one of the supports 17,18 may in such a case be locked from axial movement.

The invention may be applied in other vehicle types like an industrial tractor, or in a truck.

1. Wheel axle bearing arrangement comprising a wheel axle housing and a wheel axle support, which is configured to be rigidly connected to a vehicle frame, and a bearing arrangement configured to pivotably mount the wheel axle housing relative to the wheel axle support wherein the bearing arrangement comprises at least two bearing sleeves arranged side by side.

2. Wheel axle bearing arrangement according to claim 1, wherein at least one of the bearing sleeves is discontinuous in its circumferential direction.

3. Wheel axle bearing arrangement according to claim 2, wherein the bearing sleeve is flexible in that the sleeve's ends may be displaced relative to one another.

4. Wheel axle bearing arrangement according to claim 1, wherein at least one of the bearing sleeves is arranged in such a manner that it is permitted to move relative to an adjacent surface of the wheel axle housing.

5. Wheel axle bearing arrangement according to claim 1, wherein opposite surfaces of the wheel axle housing and the wheel axle support define a lubrication reservoir in which the bearing sleeves are positioned, and that the reservoir is designed for being one-off filled with a lubricant.

6. Wheel axle bearing arrangement according to claim 5, wherein the lubricant is an oil.

7. Wheel axle bearing arrangement according to claim 1, wherein the bearing sleeve is formed by a non-metallic material.

8. Wheel axle bearing arrangement according to claim 1, wherein the bearing sleeve is formed by a thermoset material.

9. Wheel axle bearing arrangement according to claim 1, wherein the bearing sleeve is formed by a reinforced thermoset material.

10. Device for mounting a wheel axle housing to a vehicle frame, comprising two wheel axle supports, one on each side of a central part of the wheel axle housing, which supports are configured to be rigidly connected to the vehicle frame, the wheel axle bearing arrangement according to claim 1 being arranged in a first of the wheel axle supports, and the wheel axle housing is mounted to the other, second wheel axle support via a bearing arrangement which obstructs the wheel axle housing from linear movements relative to the second wheel axle support.

11. Mounting device according to claim 10, wherein the bearing arrangement comprises at least one roller bearing.

12. Vehicle comprising a wheel axle housing bearing arrangement according to claim 1.

13. Work vehicle comprising a wheel axle bearing arrangement according to claim 1.

14. Work vehicle according to claim 13, wherein the work vehicle is articulated.
